(19) United States
(12) Patent Application Publication
(10) Pub. No.: US 2026/0358678 A1
(43) Pub. Date: Nov. 12, 2026

(54) CAMERA MODULE

(71) Applicant: SAMSUNG ELECTRO-MECHANICS CO., LTD., Suwon-si (KR)

(72) Inventors: Jae Sung OH, Suwon-si (KR); Min Jeong KANG, Suwon-si (KR); Bo Sung SEO, Suwon-si (KR); Nam Ju LEE, Suwon-si (KR)

(73) Assignee: SAMSUNG ELECTRO-MECHANICS CO., LTD., Suwon-si (KR)

(21) Appl. No.: 19/466,727

(22) Filed: Feb. 2, 2026

(30) Foreign Application Priority Data
May 9, 2025 (KR) 10-2025-0060337

(51) Int. Cl. G03B 5/02; G03B 3/10; G03B 17/12; G03B 17/17; H04N 23/55; H04N 23/68

(52) U.S. Cl. CPC G03B 5/02; G03B 3/10; G03B 17/12; G03B 17/17; H04N 23/55; H04N 23/687; G03B 2205/0069

(57) ABSTRACT

A camera module includes a plurality of lens modules; a reflection module rotatably disposed to selectively transmit light to the plurality of lens modules; a housing configured to accommodate the plurality of lens modules and the reflection module; and a plurality of guide balls, disposed between the reflection module and the housing, configured to roll along a rotation direction of the reflection module.

### CROSS-REFERENCE TO RELATED APPLICATIONS

This application claims the benefit under 35 USC 119(a) of Korean Patent Application No. 10-2025-0060337 filed on May 9, 2025, in the Korean Intellectual Property Office, the entire disclosure of which is incorporated herein by reference for all purposes.

### BACKGROUND

### 1. Field

The present disclosure relates to a camera module.

### 2. Description of the Background

A camera module employing a method of bending an optical propagation path by disposing a reflection module in front of a lens module is adopted in a mobile device. The reflection module may include a reflective member for reflecting light.

In addition, the camera module may include an image stabilization function for performing image stabilization during capturing of an image to improve resolution. The image stabilization function may be implemented by two-axis rotation of the reflective member included in the reflection module.

In addition, recently, a structure has also been proposed in which a plurality of camera modules having different optical characteristics are mounted in a portable electronic device.

However, when each of the plurality of camera modules includes the reflection modules, the structure may become excessively complicated.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a plurality of lens modules; a reflection module rotatably disposed to selectively transmit light to the plurality of lens modules; a housing configured to accommodate the plurality of lens modules and the reflection module; and a plurality of guide balls, disposed between the reflection module and the housing, configured to roll along a rotation direction of the reflection module.

The camera module may further include a first ball forming a rotation axis of the reflection module. The plurality of guide balls may be disposed around the first ball.

The rotation axis may be perpendicular to a bottom surface of the housing on which the reflection module is supported.

A plurality of guide grooves may be formed in opposing surfaces of the housing and the reflection module.

The plurality of guide grooves may include a first guide groove and a second guide groove formed in the housing, and a third guide groove and a fourth guide groove formed in the reflection module. The first guide groove and the third guide groove may oppose each other, and the second guide groove and the fourth guide groove may oppose each other.

The first ball may be disposed between the first guide groove and the third guide groove. The first ball may be in a three-point contact with each of the first guide groove and the third guide groove.

The plurality of guide balls may be disposed between the second guide groove and the fourth guide groove. Either one or both of the second guide groove and the fourth guide groove may include a plurality of partitions protruding in a rotation-axis direction of the reflection module.

A number of the plurality of guide balls may be three or more. One of the plurality of partitions may be disposed between two adjacent guide balls among the plurality of guide balls.

The plurality of partitions may be disposed around the rotation axis of the reflection module at intervals of 120°.

A height of each of the plurality of partitions may be greater than half of a diameter of each of the plurality of guide balls.

A first guide groove may be formed in the housing, a second guide groove may be formed in a holder, each of inner and outer edges of the first guide groove may have a concentric circular shape, each of inner and outer edges of the second guide groove may have a concentric circular shape, and the plurality of guide balls may be disposed between the first guide groove and the second guide groove.

The camera module may further include a driving unit including a magnet part disposed on a holder and a coil part disposed to oppose the magnet part. One surface of the magnet part opposing the coil part may have north poles (N-poles) and south poles (S-poles) alternately and repeatedly disposed along the rotation direction of the reflection module.

The coil part may include a plurality of coils, and each of the plurality of coils may face two opposite polarities of the magnet part.

Each of the plurality of lens modules may be movable in at least one of three axis directions perpendicular to one another.

Each of the plurality of lens modules may have an optical axis disposed in a direction perpendicular to the rotation axis of the reflection module. Each of the plurality of lens modules may be movable along a respective optical axis.

Each of the plurality of lens modules may include either one or both of a lens and an image sensor, and the image sensor may be movable relative to the lens.

Other features and aspects will be apparent from the following detailed description, the drawings, and the claims.

### BRIEF DESCRIPTION OF DRAWINGS

FIG. 1 is a schematic cross-sectional view of a camera module according to an example embodiment of the present disclosure.

FIG. 2 is a schematic cross-sectional view of a camera module according to another example embodiment of the present disclosure.

FIG. 3 is a schematic cross-sectional view of the camera module according to another example embodiment of the present disclosure.

FIGS. 4 - 7 are schematic plan views of a camera module according to various example embodiments of the present disclosure.

FIG. 8 is a schematic cross-sectional view of a reflection module included in the camera module according to an example embodiment of the present disclosure.

FIG. 9 is a plan view illustrating a support part of the reflection module according to an example embodiment.

FIG. 10 is a schematic perspective view of a driving unit included in the camera module according to an example embodiment of the present disclosure.

FIG. 11 is a modified example of the driving unit illustrated in FIG. 10.

FIG. 12 is a schematic cross-sectional view of a reflection module included in the camera module according to another example embodiment of the present disclosure.

FIG. 13 is a plan view illustrating a support part of the reflection module according to another example embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The present disclosure relates to a camera module, and the camera module may be mounted in a portable electronic device such as a mobile communication terminal, a smartphone, or a tablet personal computer (PC).

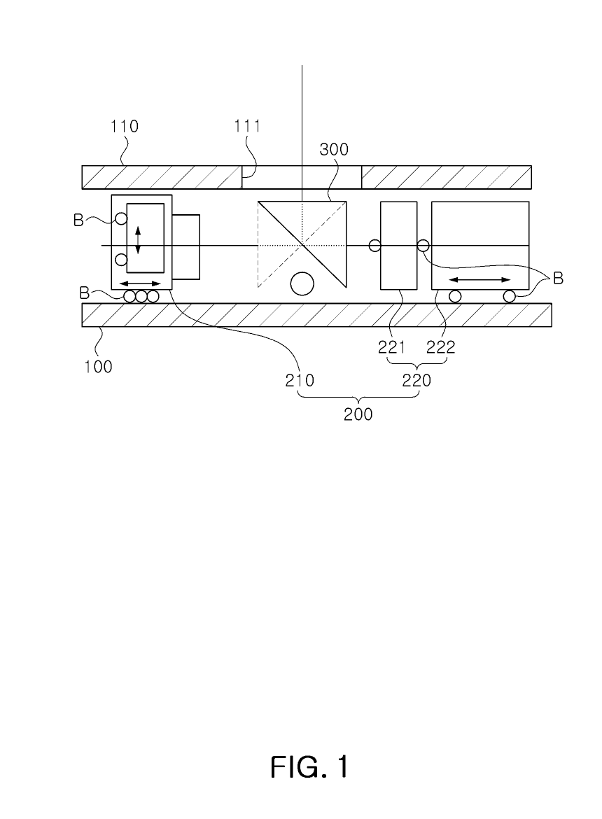

FIG. 1 is a schematic cross-sectional view of a camera module according to an example embodiment of the present disclosure.

Referring to FIG. 1, the camera module according to an example embodiment of the present disclosure may include a housing 100, a plurality of lens modules 200, a reflection module 300, and a case 110.

The plurality of lens modules 200 may be accommodated in the housing 100.

The housing 100 may include an inner space for accommodating the plurality of lens modules 200.

The reflection module 300 may include a reflective member 320 having a reflective surface and being accommodated in the housing 100. In addition, the reflection module 300 may be disposed between the plurality of lens modules 200.

The reflection module 300 may be configured to change a propagation path of light incident on the camera module. In addition, the reflection module 300 may be rotatable about a rotation axis corresponding to a direction in which light is incident on the camera module.

Accordingly, light may be selectively transmitted to any one of the plurality of lens modules 200 by the rotation of the reflection module 300.

In an example embodiment, the plurality of lens modules 200 may include a first lens module 210 and a second lens module 220. Each lens module may include at least one lens.

Optical axes of the first lens module 210 and the second lens module 220 may be respectively formed perpendicular to a direction in which light is incident on the camera module.

For example, the optical axes of the first lens module 210 and the second lens module 220 may both be perpendicular to a rotation axis of the reflection module 300.

The case 110 may be coupled to the housing 100 to cover an upper portion of the housing. The case 110 may include an opening 111, and light reflected from a subject may be incident into the camera module through the opening 111. The rotation axis of the reflection module 300 may be perpendicular to the opening 111.

One opening 111 may be formed in the case 110, and a propagation direction of light incident through the opening 111 of the case 110 may be changed based on a position of the reflection module 300. Accordingly, light may be selectively transmitted to the plurality of lens modules 200 having various optical characteristics.

Each of the first lens module 210 and the second lens module 220 may have either one or both of a focus adjustment function and an image stabilization function. That is, each of the first lens module 210 and the second lens module 220 may be movable in at least one of three axis directions perpendicular to one another.

For example, the first lens module 210 may be moved along an optical axis direction of the first lens module 210 to perform the focus adjustment.

A plurality of ball members B may be disposed between the first lens module 210 and the housing 100, and the plurality of ball members B may be configured to perform rolling movement along an optical axis of the first lens module 210.

In addition, at least one lens disposed inside the first lens module 210 may be moved in a first-axis direction perpendicular to the optical axis of the first lens module 210. Accordingly, the first lens module 210 may perform image stabilization. Here, the first-axis direction may correspond to a rotation-axis direction of the reflection module 300.

The lens moved in the first-axis direction may be supported by the plurality of ball members B capable of performing rolling movement in the first-axis direction.

The second lens module 220 may include a plurality of lenses. Some of the plurality of lenses may be rotatable about an optical axis of the second lens module 220 as their rotation axes, and the remaining lenses may be movable along the optical axis of the second lens module 220.

For example, the second lens module 220 may include a first lens part 221 and a second lens part 222. The first lens part 221 may be rotatable about the optical axis of the second lens module 220, and the second lens part 222 may be movable along the optical axis of the second lens module 220. The first lens part 221 may be disposed in front of the second lens part 222. Accordingly, light passing through the first lens part 221 may be incident on the second lens part 222.

By the rotation of the first lens part 221, a second lens module 200 may perform image stabilization. The first lens part 221 may be rotatably supported by the plurality of ball members B spaced apart from each other along an optical axis of the second lens module 200.

The second lens part 222 may be moved in an optical axis direction of the second lens module 200 to perform the focus adjustment.

The plurality of ball members B may be disposed between the second lens part 222 and the housing 100, and the plurality of ball members B may be configured to perform rolling movement along the optical axis of the second lens module 200.

In an example embodiment of the present disclosure, even when the camera module has various optical characteristics, light may be incident through a single opening 111, thereby simplifying an external appearance of the camera module when mounted in the portable electronic device.

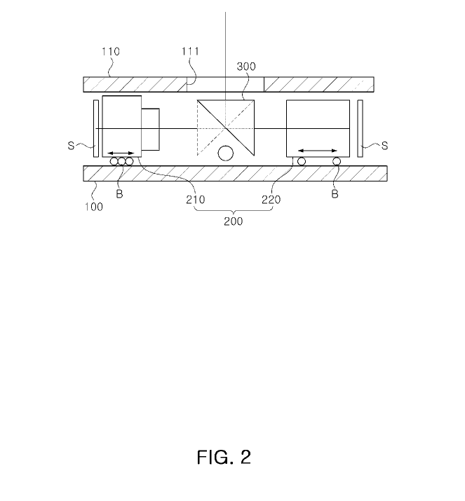

FIG. 2 is a schematic cross-sectional view of a camera module according to another example embodiment of the present disclosure.

Referring to FIG. 2, a configuration of a plurality of lens modules 200 differs from that of an example embodiment illustrated in FIG. 1.

The plurality of lens modules 200 may include a first lens module 210 and a second lens module 220.

The first lens module 210 may include at least one lens and an image sensor S. Light passing through at least one lens may be incident on the image sensor S.

The first lens module 210 may be moved along an optical axis direction of the first lens module 210. Accordingly, the first lens module 210 may perform focus adjustment. The image sensor S may be moved in a direction perpendicular to an optical axis of the first lens module 210. Accordingly, image stabilization may be performed by the movement of the image sensor S.

The second lens module 220 may include at least one lens and the image sensor S. Light passing through at least one lens may be incident on the image sensor S.

The second lens module 220 may be moved in an optical axis direction of the second lens module 220. Accordingly, the second lens module 220 may perform the focus adjustment. The image sensor S may be moved in a direction perpendicular to the optical axis of the second lens module 220. Accordingly, image stabilization may be performed by the movement of the image sensor S.

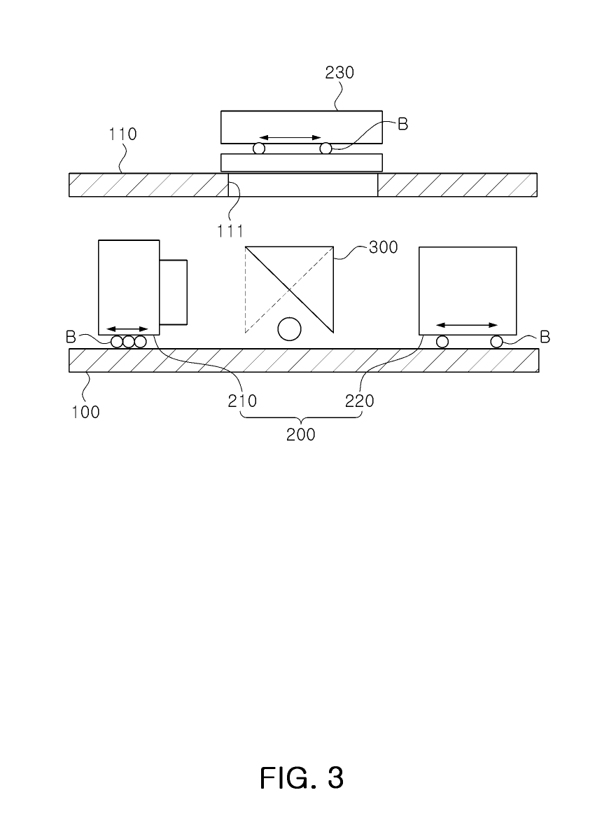

FIG. 3 is a schematic cross-sectional view of the camera module according to another example embodiment of the present disclosure.

Referring to FIG. 3, the configuration of the plurality of lens modules 200 differs from those of the example embodiments illustrated in FIGS. 1 and 2.

The plurality of lens modules 200 may include a first lens module 210, a second lens module 220, and a third lens module 230.

The third lens module 230 may include at least one lens. The third lens module 230 may be movable relative to a case 110.

For example, the third lens module 230 may be movable in a direction perpendicular to an optical axis of the third lens module 230. Accordingly, the third lens module 230 may perform image stabilization.

A plurality of ball members B may be disposed between the third lens module 230 and the case 110, and the plurality of ball members B may be disposed to perform rolling movement in the direction perpendicular to the optical axis of the third lens module 230.

In one example, the plurality of ball members B may be disposed around an opening 111 of the case 110.

Each of the first lens module 210 and the second lens module 220 may include at least one lens and may be movable along the optical axis of each lens module. Accordingly, each of the first lens module 210 and the second lens module 220 may perform focus adjustment.

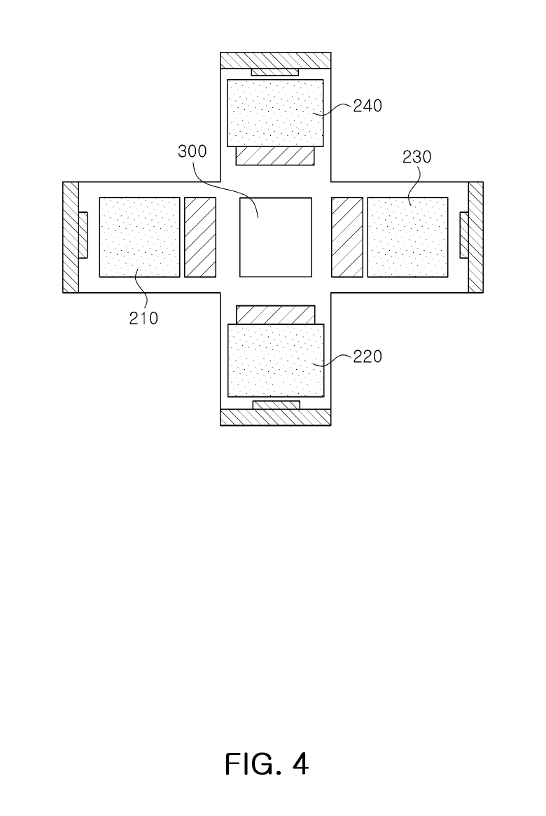

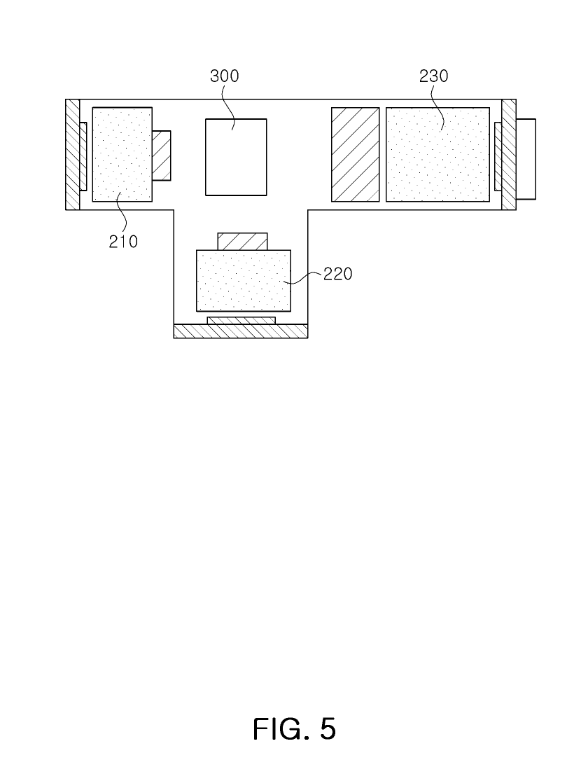

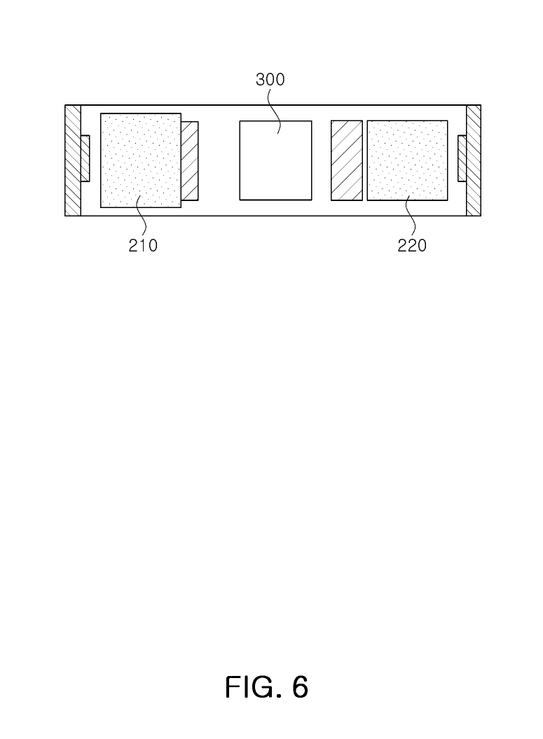

FIGS. 4 - 7 are schematic plan views of the camera module according to various example embodiments of the present disclosure.

Referring to FIGS. 4 - 7, a plurality of lens modules 200 may be disposed around a reflection module 300.

For example, the reflection module 300 may be positioned at the center, and the plurality of lens modules 200 may be disposed to be spaced apart from each other around the reflection module 300.

Each lens module may have a different optical characteristic (for example, an angle of view or a focal length), and each lens module 200 may include at least one of the focus adjustment function and the image stabilization function.

By rotation of the reflection module 300, light may be transmitted to any one of the plurality of lens modules 200.

Accordingly, light may be selectively transmitted to the plurality of lens modules 200 having various optical characteristics.

Referring to FIG. 4, a first lens module 210, a second lens module 220, a third lens module 230, and a fourth lens module 240 may be disposed around the reflection module 300.

An angle between an optical axis of the first lens module 210 and an optical axis of the second lens module 220 may be 90°. An angle between the optical axis of the second lens module 220 and an optical axis of the third lens module 230 may be 90°. An angle between the optical axis of the third lens module 230 and an optical axis of the fourth lens module 240 may be 90°. An angle between the optical axis of the fourth lens module 240 and the optical axis of the first lens module 210 may be 90°.

Referring to FIG. 5, a first lens module 210, a second lens module 220, and a third lens module 230 may be disposed around the reflection module 300.

An angle between an optical axis of the first lens module 210 and an optical axis of the second lens module 220 may be 90°. An angle between the optical axis of the second lens module 220 and an optical axis of the third lens module 230 may be 90°. An angle between the optical axis of the third lens module 230 and the optical axis of the first lens module 210 may be 180°.

Referring to FIG. 6, a first lens module 210 and a second lens module 220 may be disposed around the reflection module 300.

An angle between an optical axis of the first lens module 210 and an optical axis of the second lens module 220 may be 180°.

Referring to FIG. 7, a first lens module 210 and a second lens module 220 may be disposed around the reflection module 300.

An angle between an optical axis of the first lens module 210 and an optical axis of the second lens module 220 may be 90°.

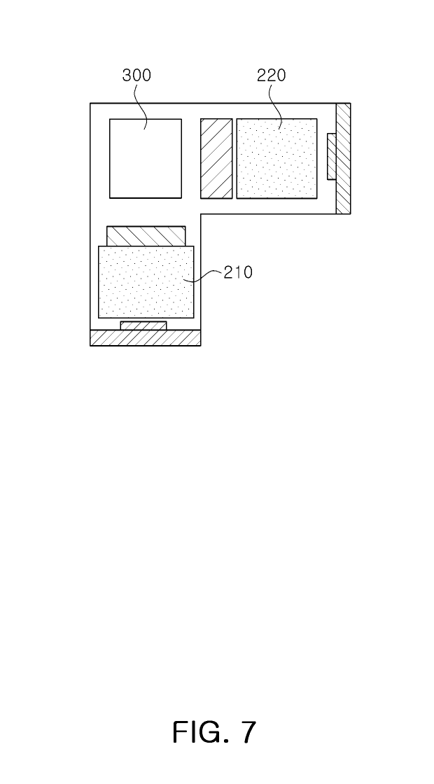

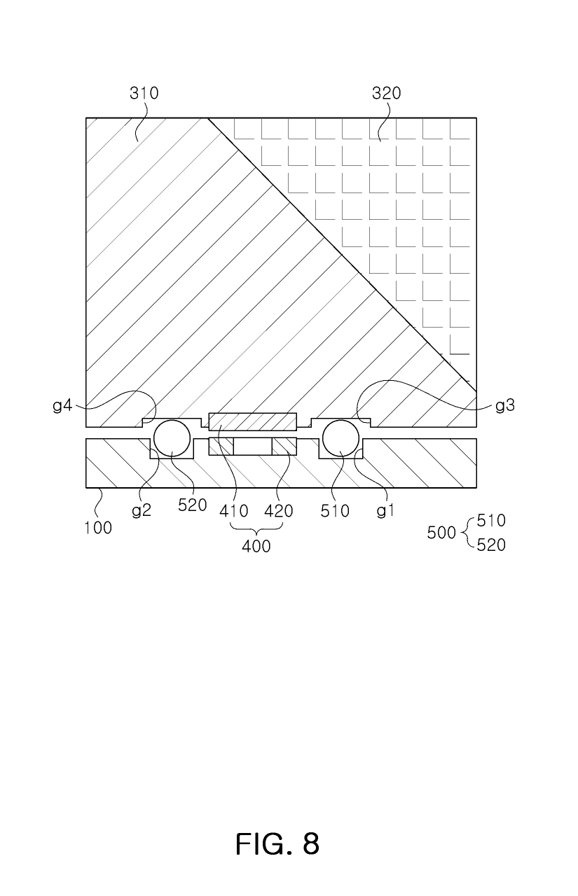

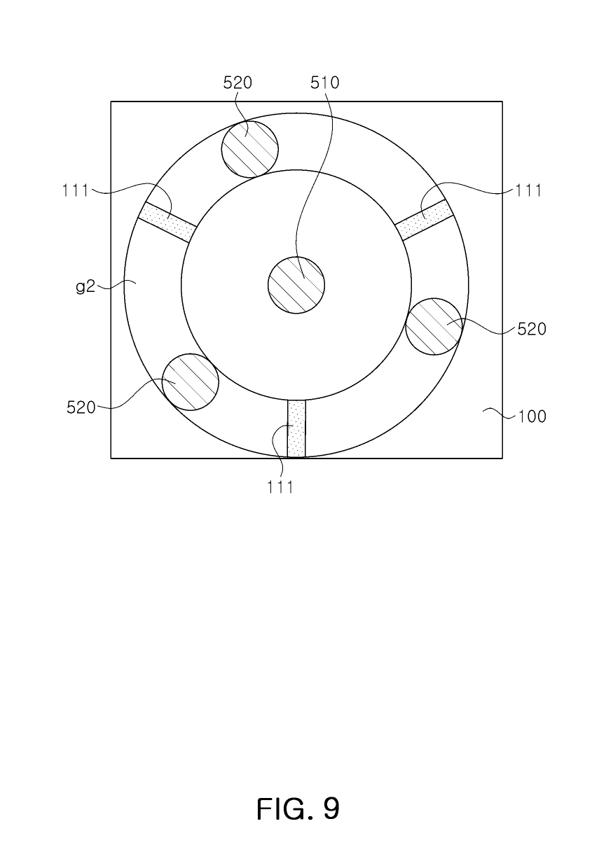

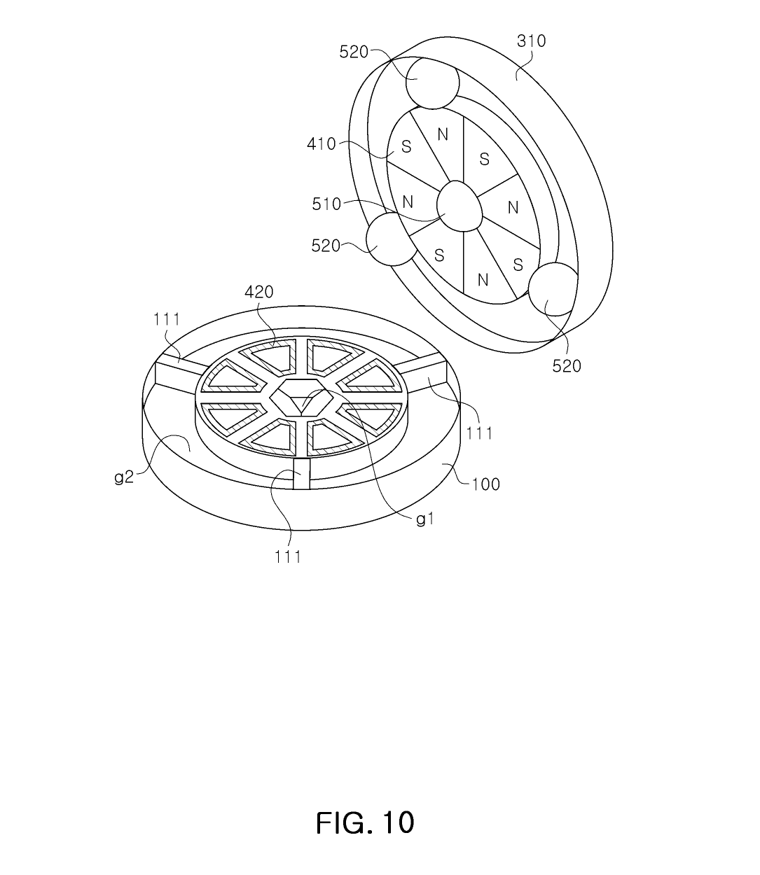

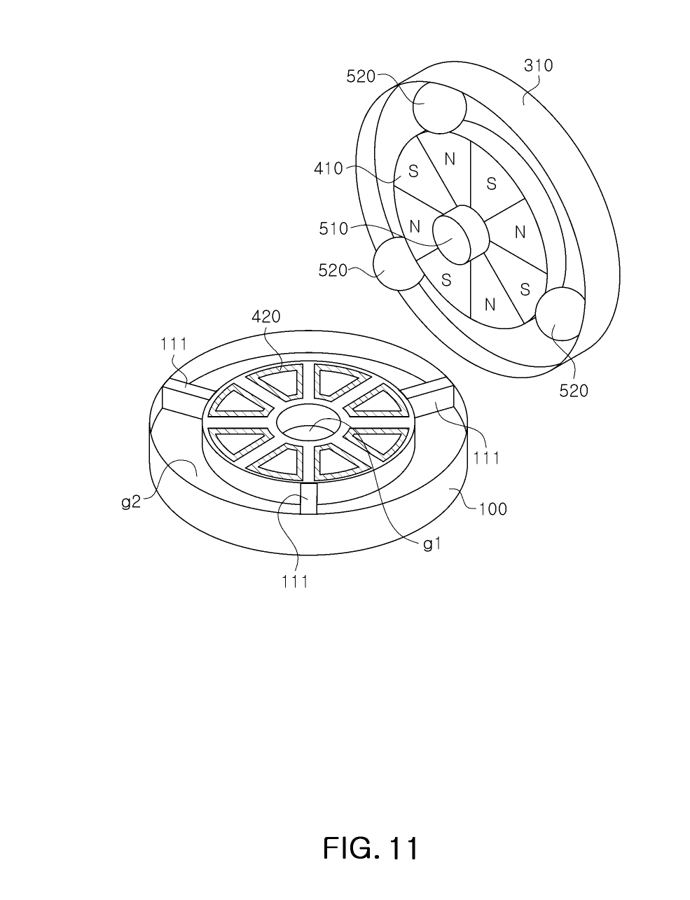

FIG. 8 is a schematic cross-sectional view of the reflection module included in the camera module according to an example embodiment of the present disclosure. FIG. 9 is a plan view illustrating a support part of the reflection module according to an example embodiment. FIG. 10 is a schematic perspective view of a driving unit included in the camera module according to an example embodiment of the present disclosure. In addition, FIG. 11 is a modified example of the driving unit illustrated in FIG. 10.

Referring to FIGS. 8 and 9, the reflection module 300 may include a holder 310 and the reflective member 320.

The reflective member 320 may have a reflective surface that reflects light. For example, the reflective member 320 may be implemented as a prism or a mirror. The reflective member 320 may be coupled to the holder 310. Accordingly, the reflective member 320 and the holder 310 may move together. The holder 310 may be rotatably disposed in the housing 100.

The reflection module 300 may be disposed to be rotatable about one axis. Here, one axis may be an axis formed along a direction in which light is incident on the camera module.

In an example embodiment, the rotation axis of the reflection module 300 may be an axis perpendicular to a bottom surface of the housing 100 included in the camera module.

A driving unit 400 may be provided to rotate the reflection module 300. The driving unit 400 may be a component included as one element included in the reflection module 300. In this case, a portion of the driving unit 400 (for example, a magnet part) may rotate together with the holder 310.

In another example, the driving unit 400 may be included as a component of the camera module and provided separately from the reflection module 300.

Referring to FIG. 10, the driving unit 400 may include a magnet part 410 and a coil part 420. The holder 310 may be rotated relative to the housing 100 by the driving unit 400.

The magnet part 410 may be mounted to the holder 310. For example, the magnet part 410 may be mounted on a lower surface of the holder 310. The lower surface of the holder 310 may refer to a surface of the holder 310 facing a bottom surface of the housing 100 in a rotation-axis direction of the holder 310.

The magnet part 410 may include at least one magnet. When the magnet part 410 includes one magnet, the magnet may be magnetized to have one surface having a plurality of north poles (N-poles) and a plurality of south poles (S-poles). In an example embodiment, the N-poles and the S-poles may be alternately and repeatedly formed on one surface of the magnet along a rotation direction of the holder 310.

When the magnet part 410 includes a plurality of magnets, each magnet may be magnetized to have one surface having the N-pole and the S-pole, and each magnet may have a polarity different from that of an adjacent magnet.

The coil part 420 may be disposed to face the magnet part 410. In an example embodiment, the coil part 420 may be disposed to face the magnet part 410 in the first-axis direction.

The coil part 420 may include a plurality of coils, and each coil may be disposed to face the N-poles and S-poles of the magnet part 410.

During image stabilization, the magnet part 410 may be a moving member mounted to the holder 310 and rotated, and the coil part 420 may be a fixed member fixed to the housing 100.

When power is applied to the driving unit 400, the driving unit 400 may generate a driving force desired for the rotation of the holder 310. For example, the driving unit 400 may generate a driving force in a direction perpendicular to the first-axis direction.

A support member 500 may be disposed between the holder 310 and the housing 100. In an example embodiment, the support member 500 may include ball members. The support member 500 may include a first ball 510 forming a rotation axis of the holder 310 and a plurality of guide balls 520 supporting the rotation of the holder 310.

When viewed from the first-axis direction, the center of the reflective member 320 may overlap with the first ball 510.

The plurality of guide balls 520 may be spaced apart from one another around the first ball 510.

A plurality of guide grooves may respectively be disposed on surfaces of the holder 310 and the housing 100 facing each other (for example, surfaces facing each other in the first-axis direction).

For example, a first guide groove g1 and a second guide groove g2 may be disposed on the housing 100, and a third guide groove g3 and a fourth guide groove g4 may be disposed on the holder 310. The first guide groove g1 and the third guide groove g3 may face each other, and the second guide groove g2 and the fourth guide groove g4 may face each other.

In an example embodiment, the first ball 510 may be disposed between the first guide groove g1 and the third guide groove g3, and the plurality of guide balls 520 may be disposed between the second guide groove g2 and the fourth guide groove g4.

The first ball 510 may be in three-point contact with the first guide groove g1 of the housing 100, and in three-point contact with the third guide groove g3 of the holder 310.

The first ball 510 may be disposed between the first guide groove g1 of the housing 100 and the third guide groove g3 of the holder 310 and form the rotation axis of the holder 310.

In another example, the first ball 510 may be provided as a protrusion protruding from the housing 100 or the holder 310. For example, as illustrated in FIG. 10, the first ball 510 may be provided as a protrusion protruding from the holder 310, and in this case, the holder 310 may not include the third guide groove g3. In addition, an end portion of the protrusion may have a hemispherical shape.

In addition, in another example, as illustrated in FIG. 11, the first ball 510 may be a protrusion protruding from the holder 310, and the protrusion may have a cylindrical shape. In this case, an outer surface of the protrusion and an inner wall of the first groove g1 of the housing 100 may be in surface contact with each other.

In an example embodiment, each of the plurality of guide balls 520 may be in two-point contact with the second guide groove g2 of the housing 100 and in one-point contact with the fourth guide groove g4 of the holder 310 (or vice versa).

In another example embodiment, each of the plurality of guide balls 520 may be in one point-contact with the second guide groove g2 of the housing 100 and in one point-contact with the fourth guide groove g4 of the holder 310.

The second guide groove g2 of the housing 100 and the fourth guide groove g4 of the holder 310 may each have inner and outer edges each having a circular shape. For example, the inner edge and the outer edge may be concentric circles.

A plurality of partitions 101 may be disposed in at least one of the second guide groove g2 of the housing 100 and the fourth guide groove g4 of the holder 310.

For example, one of the plurality of partitions 101 may be disposed between two adjacent guide balls among the plurality of guide balls 520.

When the plurality of partitions 101 are formed in the second guide groove g2 of the housing 100, the plurality of partitions 101 may protrude from a bottom surface of the second guide groove g2 of the housing 100 in the first-axis direction. A height of each of the plurality of partitions 101 may be greater than half of a diameter of each of the plurality of guide balls 520.

Accordingly, each of the plurality of guide balls 520 may perform rolling movement in a space partitioned by the plurality of partitions 101.

In an example embodiment, the second guide groove g2 of the housing 100 may be formed in a circular shape continuously along the rotation direction of the holder 310, and the plurality of partitions 101 may be formed in the second guide groove g2 while being spaced apart from one another. The plurality of partitions 101 may be disposed around the center of the first guide groove g1 at intervals of 120°.

The driving unit 400 may be disposed between the plurality of guide balls 520 and the first ball 510. For example, the magnet part 410 may be positioned between the third guide groove g3 and the fourth guide groove g4 of the holder 310, and the coil part 420 may be positioned between the first guide groove g1 and the second guide groove g2 of the housing 100.

Attractive force may act between the holder 310 and the housing 100. In an example embodiment, a pulling yoke may be disposed to face the magnet part 410 in the first-axis direction.

The magnet part 410 and the pulling yoke may generate attractive force between each other. For example, the pulling yoke may be made of a magnetic material. The attractive force may act between the magnet part 410 and the pulling yoke in the first-axis direction.

By the attractive force between the magnet part 410 and the pulling yoke, the ball member B may maintain contact with each of the holder 310 and the housing 100.

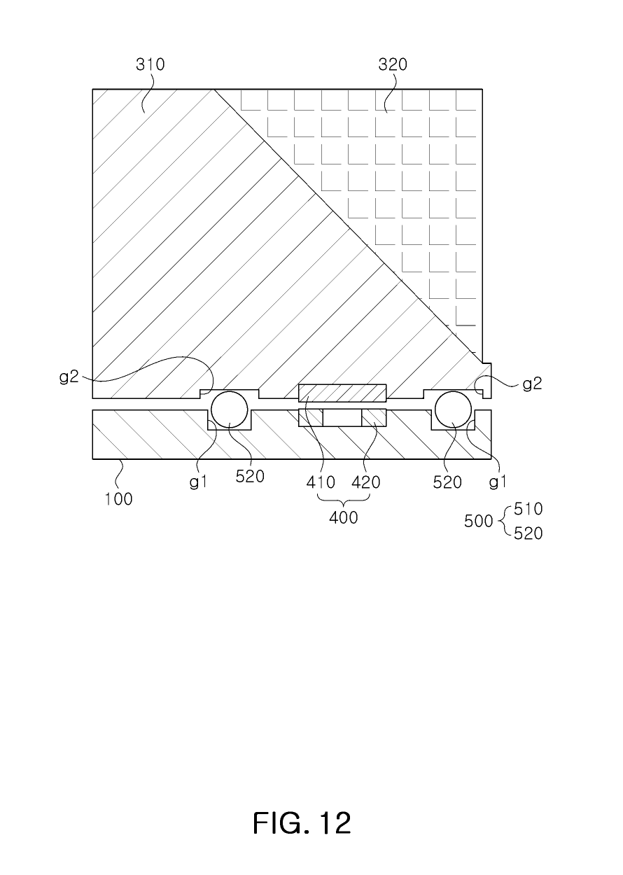

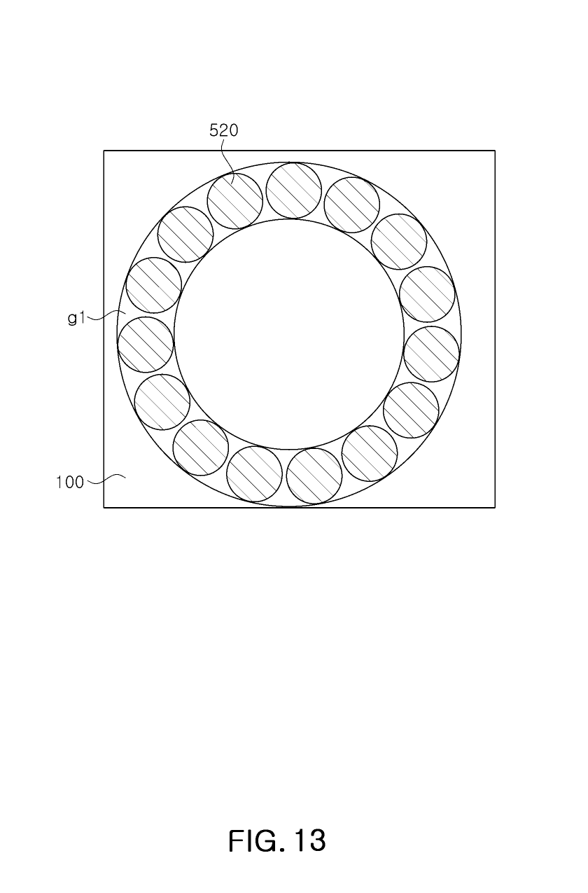

FIG. 12 is a schematic cross-sectional view of the reflection module included in the camera module according to another example embodiment of the present disclosure, and FIG. 13 is a plan view illustrating the support part of the reflection module according to another example embodiment.

Referring to FIGS. 12 and 13, the reflection module 300 may be disposed to be rotatable about one axis. Here, one axis may be an axis formed along the direction in which light is incident on the camera module.

For example, the rotation axis of the reflection module 300 may be an axis perpendicular to the bottom surface of the housing 100 included in the camera module.

The ball member B may be disposed between the holder 310 and the housing 100. The ball member B may include the plurality of guide balls 520 that perform rolling movement along the rotation direction of the holder 310. The plurality of guide balls 520 may be disposed outside the driving unit 400.

Guide grooves may respectively be disposed on surfaces of the holder 310 and the housing 100 facing each other (for example, surfaces facing each other in the first-axis direction).

For example, a first guide groove g1 may be formed in the housing 100, and a second guide groove g2 may be formed in the holder 310. The first guide groove g1 and the second guide groove g2 may face each other.

The plurality of guide balls 520 may be disposed between the first guide groove g1 and the second guide groove g2.

Each guide ball may be in two-point contact with the first guide groove g1 of the housing 100 and in two-point contact with the second guide groove g2 of the holder 310.

The first guide groove g1 of the housing 100 and the second guide groove g2 of the holder 310 may each have inner and outer edges each having a circular shape. For example, the inner edge and the outer edge may be concentric circles.

The rotation axis of the holder 310 may be formed at the center of a region defined by the first guide groove g1 of the housing 100 (or a region defined by the second guide groove g2 of the holder 310).

In an example embodiment, the plurality of guide balls 520 may include main guide balls each having a relatively large diameter and auxiliary guide balls each having a relatively small diameter.

The number of main guide balls may be at least three, and the number of auxiliary guide balls may be greater than the number of main guide balls. When the number of main guide balls is three, an angle between the three main guide balls may be 120°.

In one or more embodiments, a camera module has a simplified structure while including a plurality of lens modules.

As set forth above, the camera module according to an example embodiment of the present disclosure may simplify the structure while including the plurality of lens modules.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a plurality of lens modules;
a reflection module rotatably disposed to selectively transmit light to the plurality of lens modules;
a housing configured to accommodate the plurality of lens modules and the reflection module; and
a plurality of guide balls, disposed between the reflection module and the housing, configured to roll along a rotation direction of the reflection module.

2. The camera module of claim 1, further comprising a first ball forming a rotation axis of the reflection module,
wherein the plurality of guide balls are disposed around the first ball.

3. The camera module of claim 2, wherein the rotation axis is perpendicular to a bottom surface of the housing on which the reflection module is supported.

4. The camera module of claim 2, wherein a plurality of guide grooves are formed in opposing surfaces of the housing and the reflection module.

5. The camera module of claim 4, wherein
the plurality of guide grooves comprise a first guide groove and a second guide groove formed in the housing, and a third guide groove and a fourth guide groove formed in the reflection module,
the first guide groove and the third guide groove oppose each other, and
the second guide groove and the fourth guide groove oppose each other.

6. The camera module of claim 5, wherein
the first ball is disposed between the first guide groove and the third guide groove, and
the first ball is in a three-point contact with each of the first guide groove and the third guide groove.

7. The camera module of claim 5, wherein the plurality of guide balls are disposed between the second guide groove and the fourth guide groove, and
wherein either one or both of the second guide groove and the fourth guide groove comprise a plurality of partitions protruding in a rotation-axis direction of the reflection module.

8. The camera module of claim 7, wherein a number of the plurality of guide balls is three or more, and
wherein one of the plurality of partitions is disposed between two adjacent guide balls among the plurality of guide balls.

9. The camera module of claim 8, wherein the plurality of partitions are disposed around the rotation axis of the reflection module at intervals of 120°.

10. The camera module of claim 7, wherein a height of each of the plurality of partitions is greater than half of a diameter of each of the plurality of guide balls.

11. The camera module of claim 1, wherein
a first guide groove is formed in the housing,
a second guide groove is formed in a holder,
each of inner and outer edges of the first guide groove has a concentric circular shape,
each of inner and outer edges of the second guide groove has a concentric circular shape, and
the plurality of guide balls are disposed between the first guide groove and the second guide groove.

12. The camera module of claim 1, further comprising a driving unit comprising a magnet part disposed on a holder and a coil part disposed to face the magnet part,
wherein one surface of the magnet part opposing the coil part has north poles (N-poles) and south poles (S-poles) alternately and repeatedly disposed along the rotation direction of the reflection module.

13. The camera module of claim 12, wherein the coil part comprises a plurality of coils, and
each of the plurality of coils faces two opposite polarities of the magnet part.

14. The camera module of claim 1, wherein each of the plurality of lens modules is movable in at least one of three axis directions perpendicular to one another.

15. The camera module of claim 1, wherein each of the plurality of lens modules has an optical axis disposed in a direction perpendicular to the rotation axis of the reflection module, and
wherein each of the plurality of lens modules is movable along a respective optical axis.

16. The camera module of claim 15, wherein each of the plurality of lens modules comprises either one or both of a lens and an image sensor, and
wherein the image sensor is movable relative to the lens.
